(19) United States
(12) Patent Application Publication
(10) Pub. No.: US 2012/0272246 A1
(43) Pub. Date: Oct. 25, 2012

(54) DYNAMICALLY SCALABLE PER-CPU COUNTERS

(75) Inventor: Balbir Singh, Bangalore (IN)

(73) Assignee: INTERNATIONAL BUSINESS MACHINES CORPORATION, Armonk, NY (US)

(21) Appl. No.: 13/541,394

(22) Filed: Jul. 3, 2012

Related U.S. Application Data
(63) Continuation of application No. 12/960,826, filed on Dec. 6, 2010.

(51) Int. Cl. G06F 9/50

(52) U.S. Cl. 718/101

(57) ABSTRACT

Embodiments include a multiprocessing method including obtaining a local count of a processor event at each of a plurality of processors in a multiprocessor system. A total count of the processor event is dynamically updated to include the local count at each processor having reached an associated batch size. The batch size associated with one or more of the processors is dynamically varied according to the value of the total count.

### CROSS-REFERENCE TO RELATED APPLICATIONS

This application is a continuation of co-pending U.S. patent application Ser. No. 12/960,826, filed on Dec. 6, 2010.

### BACKGROUND

1. Field of the Invention

The present invention relates generally to symmetric multiprocessing, and more particularly to distributed counters in a multiprocessor system.

2. Background of the Related Art

Multiprocessing is a type of computer processing in which two or more processors work together to process program code simultaneously. A multiprocessor system includes multiple processors, such as central processing units (CPUs), sharing system resources. Symmetric multiprocessing (SMP) is one example of a multiprocessor computer hardware architecture, wherein two or more identical processors are connected to a single shared main memory and are controlled by a single instance of an operating system (OS). In general, multiprocessor systems execute multiple processes or threads faster than systems that execute programs or threads sequentially on a single processor. The actual performance advantage offered by multiprocessor systems is a function of a number of factors, including the degree to which parts of a multithreaded process and/or multiple distinct processes can be executed in parallel and the architecture of the particular multiprocessor system used.

### BRIEF SUMMARY

One embodiment is directed to a multiprocessing method. According to the method, a local count of a processor event is obtained at each of the processors in a multiprocessor system. A total count of the processor event is dynamically updated to include the local count at each processor having reached an associated batch size. The batch size associated with one or more of the processors is dynamically varied according to the value of the total count. The method may be implemented by a computer executing computer usable program code embodied on a computer usable storage medium.

### BRIEF DESCRIPTION OF THE SEVERAL VIEWS OF THE DRAWINGS

FIG. 1 is a schematic diagram of a multiprocessor system with a distributed reference counting system according to an embodiment of the invention.

FIG. 2 is a graph that qualitatively describes the effect of varying the batch size on the scalability.

FIG. 3 is a graph providing an example of a defined relationship between the global counter value and the batch size of a per-CPU counter according to an embodiment of the invention.

FIG. 4 is a graph providing another example of a defined relationship between the global counter value and the batch size of a per-CPU counter according to another embodiment of the invention.

### DETAILED DESCRIPTION

Embodiments of the present invention include a reference counting system for a multiprocessor system, wherein each of a plurality of per-CPU counters has a dynamically variable batch size. Generally, counting techniques are used in a computer system to track and account for system resources, which is particularly useful in a scalable subsystem such as a multiprocessor system. A counter may contain hardware and/or software elements used to count hardware-related activities. In a multiprocessor system, distributed reference counters may be used, for example, to track cache memory accesses. Conventionally, the per-CPU processors have a fixed batch size. By contrast, embodiments of the present invention introduce the novel use of a dynamically variable batch size, wherein each CPU's batch size is kept independently and varied dynamically depending on a target or limit value. For example, in a hierarchical counting mechanism each counter may be split to provide a separate count for each CPU. The separate counts are dynamically totaled into a global counter variable. Each CPU may have a batch size that is dynamically varied as a function of the global counter value. The dynamically varied batch size optimizes scalability and accuracy by initially providing a larger batch size to one or more of the counters and reducing the batch size as the global counter approaches a limit value.

The disclosed embodiments provide the ability to vary the desired scalability. In some instances it will be desirable to scale-up a distributed reference counting system, which allows for adding resources and realizing proportional benefits. At other times, it will be desirable to scale down. In this context, dynamic scalability allows the counters to scale to a larger batch size when a global counter value is far from a target value. The scalability is reduced as the global count approaches the target, so that uncertainties in counting normally attributed to a large batch size are reduced and the counting system is nearly serialized. However, after the global counter reaches the target value, the global counter value may be reset and the local counters can return to the use of a large batch size to increase scalability.

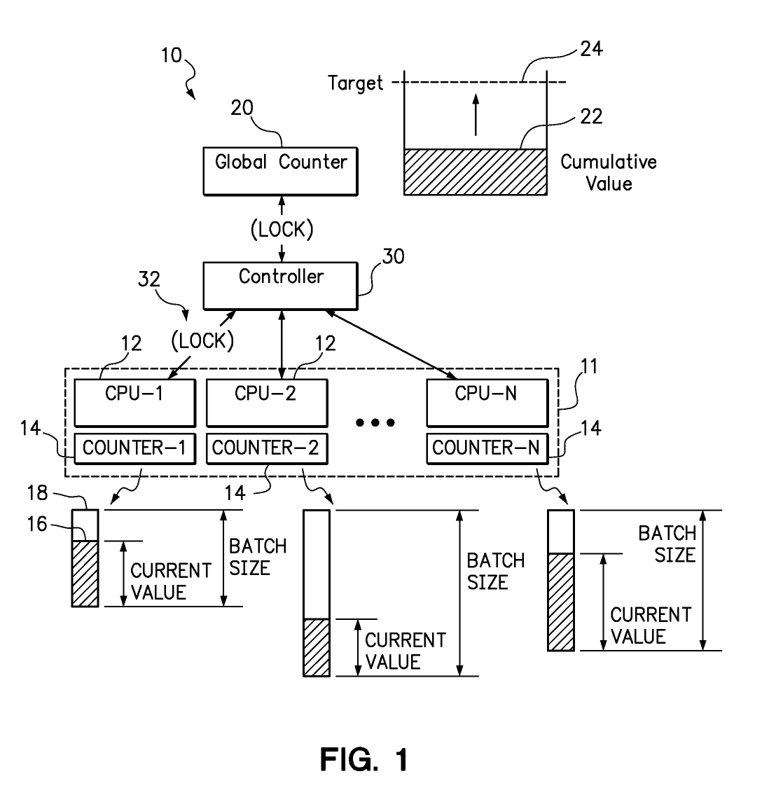

FIG. 1 is a schematic diagram of a multiprocessor system 10 with a distributed reference counting system according to an embodiment of the invention. The multiprocessor system 10 includes a processor section 11 having a quantity “N” of processors (CPUs) 12. The processors 12 may be individually referred to, as labeled, from CPU-1 to CPU-N. Each processor 12 may be, for example, a distinct CPU mounted on a system board. Alternatively, one or more of the processors 12 may be a distinct core of a multi-core CPU having two or more independent cores combined into a single integrated circuit die or “chip.” Current examples of multi-core processors include dual-core processors containing two cores per chip, quad-core processors containing four cores per chip, and hexa-core processors containing six cores per chip. The processors 12 may be interconnected using, for example, buses, crossbar switches, or on-chip mesh networks, as generally understood in the art. Mesh architectures, for example, provide nearly linear scalability to much higher processor counts than buses or crossbar switches. Simultaneous multithreading (SMT) may be implemented on the processors 12 to handle multiple independent threads of execution, to better utilize the resources provided by modern processor architectures.

The multiprocessor system 10 includes a plurality of distributed reference counters 14 and a global counter 20 for tracking occurrences of a processor event in the processor section 11. As used herein, the term “processor event” refers to a particular recurring and discretely-countable event associated with any one of the processors 12. One example of a recurring, discretely-countable processor event is a memory cache access to one of the processors 12. This multiprocessor system 10 supports a variety of different counting purposes, including statistical accounting of a particular resource being used, whether free or changing state. The accounting may be output to an end user for analyzing the system or more generically for system performance. However, the system is not limited to performance-related accounting. Each reference counter 14 is uniquely associated with a respective one of the processors 12 for counting occurrences of a processor event associated with that processor 14. Accordingly, each counter 14 may be referred to alternately as a local counter (i.e., local to a specific processor) or a “per-CPU” counter 14. The global counter 20 is for tracking the total occurrences of that processor event. The global counter 20 is dynamically updated with the individual counts of the per-CPU counters 14, as further described below. The global counter 20 resides in memory. In the present embodiment, the global counter 20 is a software object, which is usually serialized during access.

To simplify discussion, the global counter 20 and the per-CPU counters 14 are each represented as single-register counters for counting the occurrences of a specific processor event. However, for the purpose of tracking a variety of different processor events, each per-CPU counter 14 and the global counter 20 may include a plurality of different registers, each for counting the occurrences of a different processor event. For example, a first register of each counter 14 may be dedicated to counting memory cache accesses, a second register of each counter 14 may be dedicated to counting occurrences of other processor events.

A controller 30 is in communication with the local, per-CPU counters 14 and with the global counter 20. The controller 30 includes both hardware and software elements used to identify and count processor events in the multiprocessor system 10. For each processor 12, the controller 30 increments a current value 16 of the CPU counter 14 associated with that processor 12 with each occurrence of the processor event counted. The controller 30 also dynamically updates the global counter 20 in response to a current value 16 of any one of the per-CPU counters 14 reaching the associated batch size 18. The global counter 20 may be updated immediately, or as soon as possible, each time any one of the per-CPU counters 14 reaches the associated batch size 18. Alternatively, the global counter 20 may be updated in response to a user requesting a global counter value, to include the local counts of each of the distributed per-CPU counters 14 that have reached their associated batch sizes 18 since the previous update of the global counter 20.

In one implementation, a per-CPU counter 14 may continue to count after reaching its associated batch size, until the next opportunity for the multiprocessor system 10 to update the global counter 20. Then, the global counter 20 is updated by adding the current value 16 of that local counter 14 to the cumulative value of the global counter 20. In an alternative implementation, the per-CPU counter 14 may stop counting as soon as it reaches the associated batch size, and the global counter 20 is immediately updated to include the associated batch size. In either case, the value of the associated local counter 14 may be reset as soon as the global counter 20 has been updated to include the previous value. This sequence is performed for each processor 12 and its associated counter 14. The global counter 20 thereby tracks the cumulative occurrences of the processor event at all of the CPU counters 14 in the processor section 11. When a cumulative value 22 of the global counter 20 reaches a predefined threshold or “target” 24, an action is initiated. For example, the threshold may be a limit on the usage of a resource, which triggers an action. For example, the system 10 may be used in counting the amount of memory a process is consuming. Such as process can be threaded and run in parallel on the multiple processors 12. The threads can attempt to update the usage in parallel. The usage attributable to the process is tracked on the global counter 20, while the usage attributable to individual threads of that process may be tracked on the per-CPU counters 14. When the per-CPU count on a particular processor 12 reaches a particular batch size, the value of the global counter is updated. The accuracy of the global counter value can affect the functional operation, and inaccurate or fuzzy values may lead to incorrect functional operation.

This approach of updating the global counter 20 in batches is more efficient and consumes fewer resources than constantly updating the global counter 20 with each occurrence of a detected event at one of the processors 12. However, because the global counter 20 is only updated when one of the counters 14 reaches its associated batch size 18, the system may overshoot the target 24 each time the cumulative value 22 reaches the target 24. Thus, a larger batch size 18 reduces the load on system resources by reducing how often the global counter 20 is updated, and thereby increases scalability. Conversely, a smaller batch size 18 allows the global counter 20 to more accurately identify when the target 24 is reached or is almost to be reached, by imposing a smaller increment on the global counter 20 each time the global counter 20 is updated.

The multiprocessor system 10 according to this embodiment of the invention achieves an improved combination of both accuracy and scalability by dynamically varying the batch size 18. When the global counter 20 is initialized, and each time the global counter 20 is reset, the batch size 18 associated with each per-CPU counters 14 is set to an upper value, which is subsequently reduced as the cumulative value 22 of the global counter 20 increases toward the target 24. Each per-CPU counter 14 may cycle many times through to its associated batch size 18, updating the global counter value each time the batch size 18 is reached, before the global counter 20 approaches the target 24 and the batch size 18 is decreased. At some point before the global counter 20 reaches the target 24, the batch size 18 of at least one (and preferably all) of the per-CPU counters 14 is reduced, so that a smaller increment may be added to the global counter 20 each time the reduced batch size 18 is reached.

As indicated in FIG. 1 by different batch sizes 18 for each counter 14, there is no requirement that each per-CPU counter 14 has the same batch size 18 at any given moment. Thus, each CPU counter 14 may start out with a different batch size 18 selected specifically for that CPU counter 14. Typically, however, the batch size 18 of every per-CPU counter 14 may be the same, such that when the batch size 18 is reduced, that reduction is applied uniformly to every per-CPU counter 14.

The per-CPU counters 14 may be provided with mutually exclusive access to the global counter 20 when updating the global counter 20, to avoid counting errors on the global counter 20. Generally, mutual exclusion refers to algorithms used in concurrent programming (e.g. on the multiprocessor system 10) to avoid the simultaneous use of a common resource, such as a global variable, by pieces of computer code referred to as critical sections. A critical section is a piece of code in which a process or thread accesses a common resource. The critical section refers to the process or thread which accesses the common resource, while separate code may provide the mutual exclusion functionality. Here, the global counter 20 is the common resource to be accessed.

In this embodiment, locks 32 are used to provide mutual exclusion. The lock 32 is a synchronization mechanism used to enforce limits on access to the global counter 20, as a resource, in an environment where there are many threads of execution. The locks 32 may require hardware support to be implemented, using one or more atomic instructions such as “test-and-set,” “fetch-and-add,” or “compare-and-swap.” Counting can be performed using architecturally-supported atomic operations. The per-CPU counters can be synchronized, with each counter 14 holding the lock 32 to provide the necessary mutual exclusion for accessing the global counter 20. However, the incrementing of each individual counter 14 may be done lock-free, since each per-CPU counter 14 is associated with a specific processor 12 and there is no danger of another processor 12 simultaneously requiring access to the per-CPU counter 14 associated with another processor 12.

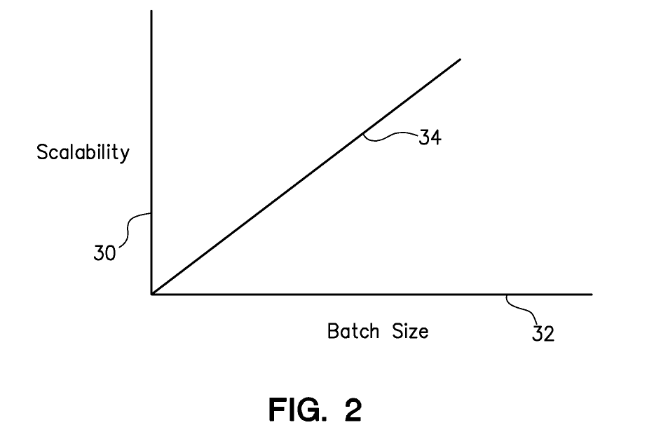

FIG. 2 is a graph that qualitatively describes the effect of varying the batch size on the scalability. A vertical axis (scalability axis) 30 represents scalability. A horizontal axis (batch size axis) 32 represents batch size. A scalability curve 34 represents the variation of scalability 30 with batch size 32. Here, the scalability 30 is shown to vary linearly with batch size 32. Thus, increasing the batch size may proportionally increase the scalability. Conversely, reducing the batch size may proportionally reduce scalability. As noted above, increasing the batch size reduces the load on the system by reducing how often the global counter is updated. However, reducing the batch size increases the accuracy of the global counter and reduces the likelihood and extent of overshooting the target value of the global counter. The batch size may be dynamically varied along the linear curve 34 according to an embodiment of the invention to dynamically achieve the desired balance of scalability and accuracy of the global counter.

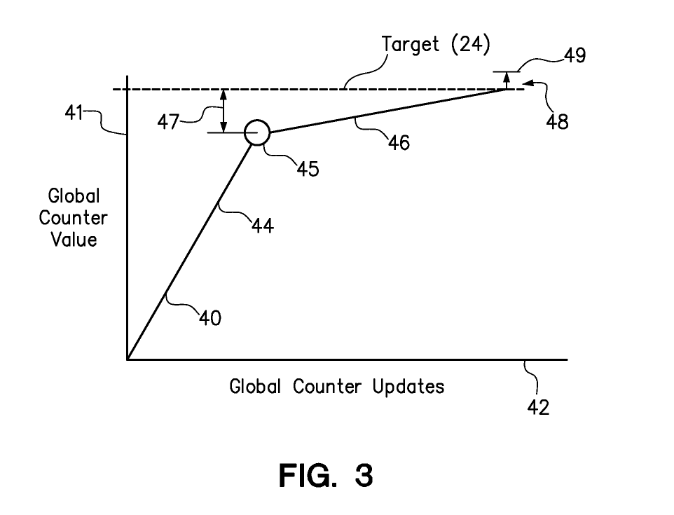

FIG. 3 is a graph providing an example of a defined relationship between the global counter value and the batch size of a per-CPU counter according to an embodiment of the invention. For example, as applied to the multiprocessor system 10 of FIG. 1, the controller 30 may enforce a predefined relationship between the global counter cumulative value 22 and the batch sizes 18 of the per-CPU counters 14. Referring still to FIG. 3, a vertical axis 41 represents the global counter cumulative value for a distributed reference counter system in a multiprocessor system as the global counter cumulative value approaches the target 24. The horizontal axis 42 represents the number of updates to the global counter. A curve 40 describes the variation of the global counter value with the number of updates or accesses to the global counter. A lower leg 44 of the curve 40 shows the expected initial variation of the global counter value with an initial (larger) batch size. An upper leg 46 of the curve 40 shows the expected variation of the global counter value with a reduced batch size.

Initially, each time the global counter is updated, the global counter value is increased by the sum of the counters having reached their associated batch size since the previous update. Thus, the lower leg 44 of the graph increases generally linearly at a relatively steep angle. A predefined “knee point” 45 is provided at a global counter value of less than the target value 24. The difference between the target value 24 and the global counter value at the knee 45 is a threshold value generally indicated at 47. When the knee point 45 is reached, the batch size is automatically decreased by a predefined amount, resulting in a slope change at the knee 45. The decrease in slope of the upper leg 46 corresponds to a decrease in scalability. As the global counter continues to be updated, the global counter value is increased by a smaller amount per update corresponding to the reduced batch size. This increase of the global counter value by progressively smaller increments may result in several such increments before the target value is reached. The global counter value (vertical axis 41) continues to vary linearly with the number of updates to the global counter, although at a more modest rate of increase (i.e., a reduced slope of the curve). The point at which the total number of occurrences of the processor event reaches or surpasses the target value 24 is represented as the intersection between the upper leg 46 and the dashed horizontal line indicated at 24.

As a result of not updating the global counter at the exact moment of reaching the target value 24, the actual number of occurrences of the processor event, indicated at 49, will exceed the target value 24 by an amount referred to in this graph as the overshoot 48. The overshoot 48 is decreased, however, by having reduced the batch size (at the knee point 45) prior to reaching the target value 24 according to this inventive aspect of dynamically adjusting the batch size. Accordingly, reducing the batch size before reaching the target 24 increases the accuracy of the global counter, i.e. how closely the global counter value reflects the actual number of occurrences of the processor event.

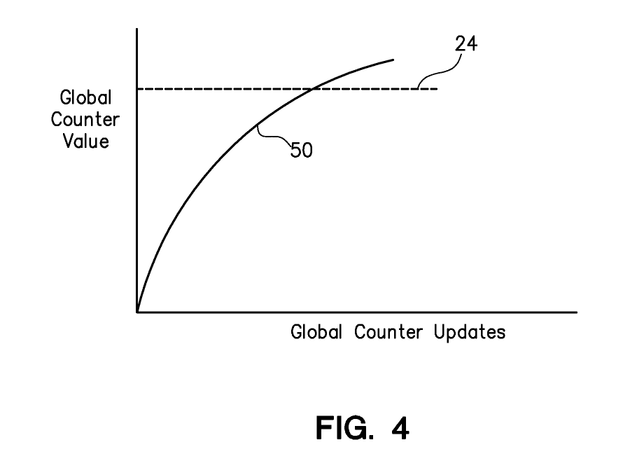

FIG. 4 is a graph providing another example of a defined relationship between the global counter value and the batch size of a per-CPU counter according to another embodiment of the invention. In this example, the curve 50 representing the defined relationship is non-linear. As the global counter value increases, the batch size is progressively reduced in a continuous fashion or in many small decrements, resulting in a generally cambered curve 50. The shape of the curve 50 represents a gradually diminishing scalability as the value of the global counter approaches the target value 24.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A multiprocessing method, comprising:
obtaining a local count of a processor event at each of a plurality of processors in a multiprocessor system;
dynamically updating a total count of the processor event to include the local count at each processor having reached an associated batch size; and
dynamically varying the batch size associated with one or more of the processors according to the value of the total count.

2. The multiprocessing method of claim 1, wherein the step of dynamically varying the batch size comprises:
dynamically decreasing the batch size as a function of the difference between a target value for the total count and a current value of the total count.

3. The multiprocessing method of claim 2, wherein the step of dynamically decreasing the batch size as a function of the difference between a target value for the total count and a current value of the total count comprises decreasing the batch size a predetermined amount when the global count reaches a predefined threshold that is less than the target value.

4. The multiprocessing method of claim 1, further comprising:
independently varying the associated batch size of each processor according to the global count.

5. The multiprocessing method of claim 1, wherein the processor event is a resource count.

6. The multiprocessing method of claim 1, further comprising:
generating a lock providing mutually exclusive access for updating the global count when the local count reaches the associated batch size.

7. The multiprocessing method of claim 1, further comprising:
updating the global counter atomically.

8. The multiprocessing method of claim 1, further comprising:
resetting the global counter value and increasing the batch size used by the local counters in response to the global counter reaching the target value.
